(19) United States
(12) Patent Application Publication
(10) Pub. No.: US 2010/0193336 A1
(43) Pub. Date: Aug. 5, 2010

(54) SWITCH FOR A MOVEABLE POLE

(75) Inventors: Michael Walton, Edmonton (CA); Robert Tauber, Edmonton (CA); James Bulmer, Sherwood Park (CA)

Correspondence Address: SUMMA, ADDITON & ASHE, P.A., 11610 NORTH COMMUNITY HOUSE ROAD, SUITE 200, CHARLOTTE, NC, 28277, US

(73) Assignee: R.O.I. LIGHTING AND CONTROLS, Edmonton (CA)

(21) Appl. No.: 12/364,026

(22) Filed: Feb. 2, 2009

(30) Foreign Application Priority Data
Jan. 30, 2009 (CA) 2651534

(51) Int. Cl. H01H 35/02

(52) U.S. Cl. 200/61.52

(57) ABSTRACT

A switch for use in a pole for situating an electrical fixture remote from a base position is described. The pole is moveable between an operating position and a maintenance position, and the switch may automatically connect/disconnect power to the electrical fixture based on the position of the pole. The switch comprises a sensor for measuring an orientation of the switch, a microcontroller for processing the orientation of the switch as measured by the sensor and providing a microcontroller output signal based on the processing of the orientation of the switch, and a controllable switch for connecting and disconnecting the electrical fixture to and from a power source based on the microcontroller output signal.

### CROSS-REFERENCE TO PRIORITY APPLICATION

This application is a continuation of and claims the benefit of the commonly assigned Canadian Patent Application Serial No. ______ (filed Jan. 30, 2009, in the Canadian Patent Office) which is hereby incorporated by reference in its entirety.

### FIELD OF THE INVENTION

The present invention relates generally to moveable elongated members or poles, and more particularly to a switch for moveable elongated members or poles with an attached electrical fixture.

### BACKGROUND

It is known to use an elongated member or pole to situate an article or fixture remotely from a base position. Such elongated members or poles may be used in processing plants, refineries, construction sites, city street lighting, etc., to situate electrical fixtures, such as lights, above the base position, which may be for example the ground or an elevated platform.

It is further known to provide such elongated members or poles with a hinge or other means for rotating the elongated member or pole from a vertical position to a generally horizontal position. One such pole is the Safe Swivel® Light Pole produced by Safe Swivel Technology Pty Ltd. The rotation of the elongated member or pole from an operating position, in which the elongated member is generally vertical, to a maintenance position, in which the elongate member or a portion thereof is generally horizontal, allows for maintenance or other tasks to be performed on the article or fixture without requiring the use of ladders or safety equipment, such as harnesses, for working from an elevated position.

The movement or rotation of the elongated member or pole from the vertical position allows for facilitated maintenance on the article or fixture. However, when the article or fixture is an electrical fixture such as a light socket or electrical outlet, there exists a risk of electrical shock from the fixture.

Previous attempts to address the risk of electrical shocks while performing maintenance on an electrical fixture have involved a manually operated switch located at or near the electrical fixture. While such a switch helps to mitigate the risk of electrical shock while performing maintenance on the electrical fixture it requires the maintenance worker to manually turn off the power to the fixture. Maintenance workers may not always operate the switch resulting in power being provided to the electrical fixture. Furthermore, even if the manual switch is operated by the maintenance worker, the manually operated switch is typically located in close physical proximity to the electrical fixture, which means that while the power may be cut off from the electrical fixture, a live power source may still be located near the fixture, giving rise to an electrical shock hazard.

A need therefore exists for a switch for connecting or disconnecting power to or from an electrical fixture mounted on a moveable or rotatable elongated member or pole that reduces the risk of electrical shock while performing maintenance on the electrical fixture.

### SUMMARY OF THE INVENTION

In accordance with the present disclosure there is provided a switch for use in a pole for situating an electrical fixture remote from a base position is described. The pole is moveable between an operating position and a maintenance position. The switch comprises a sensor for measuring an orientation of the switch, a microcontroller for processing the orientation of the switch as measured by the sensor and providing a microcontroller output signal based on the processing of the orientation of the switch, and a controllable switch for connecting and disconnecting the electrical fixture to and from a power source based on the microcontroller output signal.

In accordance with the present disclosure there is also provided a moveable pole for locating an electrical fixture remote from a base position, the moveable pole comprises a pole moveable between an operating position and a maintenance position, an electrical fixture mounted on the pole, and a switch for automatically disconnecting power from the electrical fixture when the pole is in the maintenance position.

In accordance with the present disclosure there is also provided an elongate member for locating an electrical fixture remote from a base position. The elongate member comprises an inner elongate portion, the inner elongate portion extending, in use, from the base position, an outer elongate portion, the outer elongate portion being arranged to receive the electrical fixture, an interconnecting means, the interconnecting means being arranged to connect the inner elongate portion to the outer elongate portion and to permit relative rotation of the inner and outer portions about an axis of rotation, the axis of rotation being disposed at an acute angle relative to a longitudinal axis of the inner elongate portion, and a switch mechanically coupled to the outer elongate portion and electrically coupled to the electrical fixture and a cable for electrically coupling the switch to a power source.

### BRIEF DESCRIPTION OF THE DRAWINGS

The foregoing and other objects and advantages of the invention and the manner in which the same are accomplished will become clearer based on the following detailed description taken in conjunction with the accompanying drawings in which:

FIG. 1 is a diagram showing an illustrative pole in which embodiments of the present disclosure may be used;

FIG. 2 is a block diagram showing components of an illustrative switch;

FIG. 3 is a diagram showing a cross-section of the illustrative pole and switch, with the pole in an operating position;

FIG. 4 is a diagram showing a cross-section of the illustrative pole and switch, with the pole in a maintenance position;

FIG. 5 is an electrical schematic of one example of an illustrative switch; and

FIGS. 6a, 6b and 6c are diagrams showing one example of the layout of an illustrative safety.

### DETAILED DESCRIPTION

The present invention will now be described more fully hereinafter with reference to the accompanying drawings, in which a preferred embodiment of the invention is shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

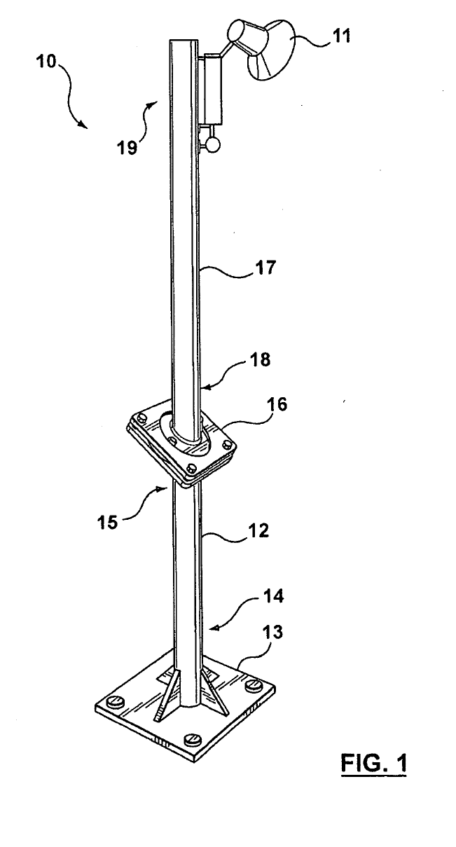

FIG. 1 shows in a diagram an illustrative elongate member 10 in which embodiments of a switch may be used. The elongate member 10 may situate an electrical fixture 11, such as a light source, above a base 13. The base 13 may be positioned on the ground or on an elevated platform. The base 13 serves to secure the elongate member 10 in the desired position. Other means for securing the elongate member 10 to, or on, a base position will be apparent to those of ordinary skill in the art.

The elongate member 10 includes a first elongate member 12 secured to the base 13, or other securing means for securing the elongate member at the base position, at a base section 14 of the first elongate member 12. The first elongate member 12 has an upper hinge section 15 for securing an interconnecting means 16 to the first elongate member 12.

The elongate member 10 further includes a second elongate member 17 that has a lower hinge section 18 and a fixture section 19 for securing an electrical fixture 11 to the elongate member 10.

The first elongate member 12 is coupled to the second elongate member 17 by the interconnecting means 16. The interconnecting means 16 is secured to the first elongate member 12 at the upper hinge section 15 of the first elongate member 12. The interconnecting means 16 is also secured to the second elongate member 17 at the lower hinge section 18 of the second elongate member 17.

The interconnecting means 16 allows the second elongate member 17 to move relative to the first elongate member 12, so as to bring the second elongate member 17 into a substantially horizontal position in which maintenance may be performed on the electrical fixture 11. The interconnecting means 16 depicted in FIG. 1 provides for rotation of the second elongate member 17 about an axis that is arranged at an angle to the first elongate member 12. The rotation of the second member 17 about the angled axis brings the second elongate member 17 into an approximately horizontal position.

Although the interconnecting means 16 is described as providing for rotation of the second elongate member 17 about an axis that is arranged at an angle to the first elongate member 12, other means for coupling the first elongate member 12 with the second elongate member 17 are possible. For example, a hinge or hinges, may allow movement of the second elongate member 17 about one or more axes. Other means for moveably connecting the first elongate member 12 to the second elongate member 17 may include a flexible connector. The interconnecting means 16 allows the second elongate member 17 to move relative to the first elongate member 12 between an operating position in which the second elongate member 17 situates the electrical fixture 11 in the desired position, and a maintenance position in which the elongate member 10 situates the electrical fixture 11 in a position suitable for performing maintenance on the electrical fixture 11. The operating position is described herein as having the second elongate member 17 in a generally vertical position, and the maintenance position as having the second elongate member 17 in a generally horizontal position. The orientation of the second elongate member 17 relative to the first elongate member 12 in both the operating position and maintenance position may be modified to suit particular requirements of an installation of the elongate member 10. For example, in a particular installation, the operating position may locate the second elongate member 17 in a generally horizontal position, and the maintenance position may locate the second elongate member 17 in a generally vertical position. The first and second elongate members 12, 17 need not be orientated in generally vertical or horizontal positions, and may be oriented at various angles in the operating and maintenance positions. Further, it should be understood that although the first elongate member 12 and the second member 17 have been described as being rotatable between the operating and maintenance positions, the first elongate member 12 and the second elongate member 17 need not rotate relative to one another. Any type of movement between the operating position and the maintenance position may be used, such as bending, flexing, hinging, etc.

Although not shown in FIG. 1, it is understood that a cable for providing power to the electrical fixture 11 can be run through the inside of the elongate member 10. The cable should be provided with enough slack to allow for the movement of the second elongate member 17 relative to the first elongate member 12 between the operating position and the maintenance position.

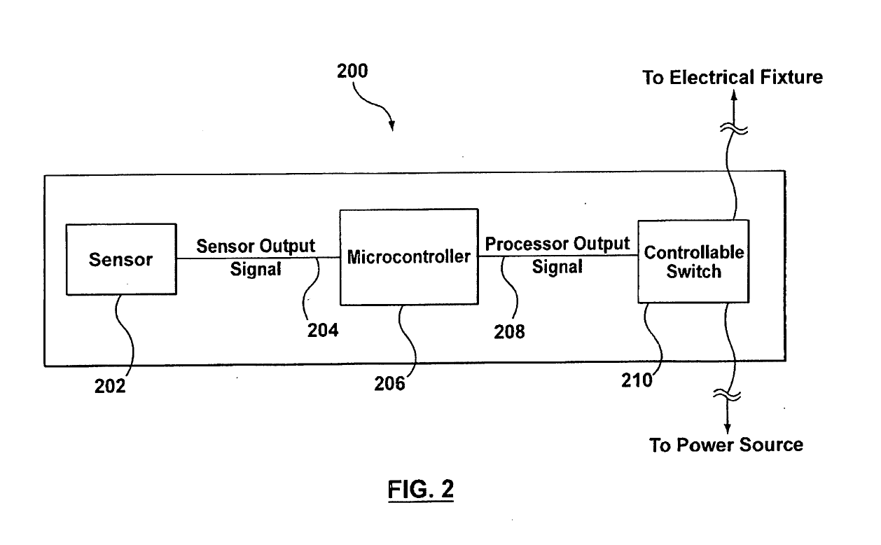

FIG. 2 shows in a block diagram components of an illustrative switch 200. The switch 200 may be used in a moveable pole. The moveable pole may be similar to the elongate member 10 as described above, with reference to FIG. 1, or may be another pole that provides movement of the pole, or a section of the pole, between an operating position and a maintenance position. The pole, or section of the pole, moves about at least one axis, or in at least one plane, when transitioning between the maintenance position and the operating position. The switch 200, when used in a moveable pole, automatically disconnects power from an electrical fixture of the pole when the pole, or section of the pole, is in the maintenance position, and connects power to the electrical fixture when the pole, or section of the pole, is in the operating position.

The switch 200 is physically coupled to the pole such that movement of the pole results in corresponding movement of the switch 200. The switch 200 is electrically connected between the electrical fixture and a power source. The switch 200 may be located within the pole near the point of movement of the pole. For example, if the pole is similar to the elongate member 10 of FIG. 1, the switch 200 may be located within the second elongate member 17 near the interconnecting means, for example in the lower hinge portion 18 of the second elongate member 17. Locating the switch 200 near the point of movement of the pole advantageously locates the point of disconnection of the power source, and so the live power cable, further from the electrical fixture and point of maintenance. This helps reduce the risk of electrical shock when performing maintenance or other work on the electrical fixture.

The switch 200 comprises a sensor 202 that provides a sensor output signal 204 in dependence upon the orientation of the sensor 202. The sensor output signal 204 is coupled to a microcontroller 206 that processes the sensor output signal 204 and generates a microcontroller output signal 208 based on the sensor output signal 204. The microcontroller output signal 208 is coupled to a controllable switch 210. The controllable switch 210 is connected between an electrical fixture and a power source, and connects/disconnects the power source to/from the electrical fixture based on the microcontroller output signal 208.

The microcontroller 206 may be a microcontroller, application specific integrated circuit (ASIC) or other circuit means. The microcontroller 206 may be implemented in hardware or in a combination of hardware and software. The microcontroller 206 processes the sensor output signal 204 to determine the orientation of the sensor 202, and so the pole, or section of the pole the switch 200 is physically coupled to when the switch 200 is used in a pole. When the microcontroller 206 determines that the sensor 202 is oriented in a particular position, for example generally horizontal which corresponds to the maintenance position, it provides the appropriate microcontroller output signal 208 to the controllable switch 210. The microcontroller 206 sets the microcontroller output signal 208 such that the controllable switch 210 disconnects power from the electrical fixture when the sensor 206 is in an orientation, which corresponds to the maintenance position when the switch 200 is used with a moveable pole, and connects power to the electrical fixture when the sensor 202 is in an orientation, which corresponds to the operating position when the switch 200 is used with a moveable pole.

The switch 200 of FIG. 2 is shown as having a single sensor 202. It is possible to include additional sensors to provide orientation detection along multiple axes. If multiple sensors 202 are used, they may be orientated orthogonal to each other. For example, three sensors 202 orientated orthogonal to each other may be used to determine the orientation of the switch 200 in three dimensions (x, y and z). The sensors 202 may be provided by various means, including for example by an accelerometer, or accelerometers. When multiple sensors 202 are present, the sensor output signal 204 may be comprised of multiple output signals, one for each sensor. Alternatively, the orientation information from the multiple sensors 202 may be encoded or multiplexed into a single sensor output signal 204.

The switch 200 may be provided with a battery or other external power source to power the components of the switch 200, for example the sensor 202, the microcontroller 204 and the controllable switch 210. It is also possible to provide the switch 200 with a transformer circuit (not shown) to enable powering the switch 200 from the power cable, which typically provides AC power.

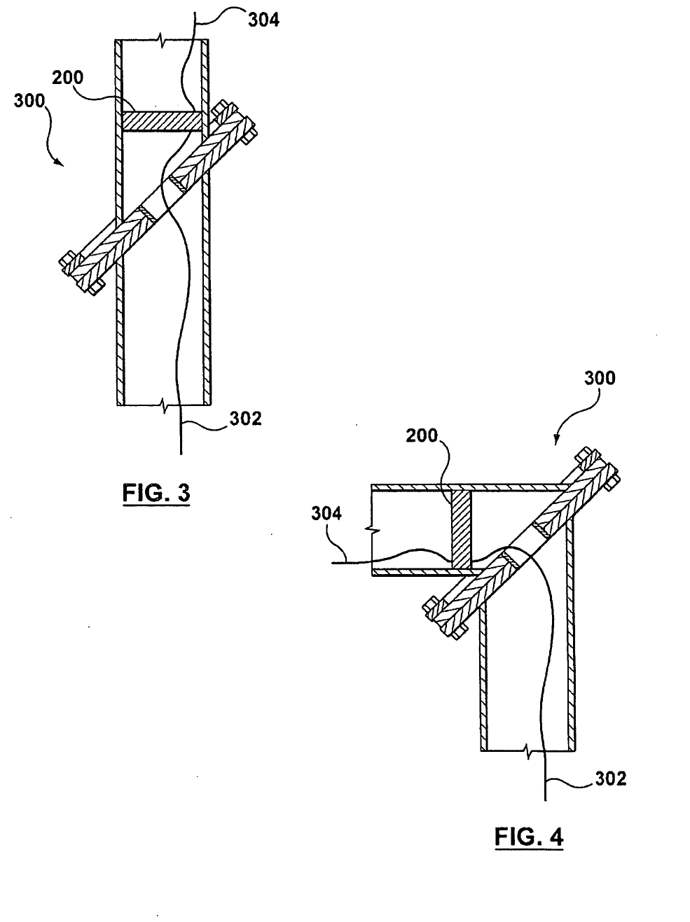

FIGS. 3 and 4 show a cross-section of a moveable pole 300, such as the elongate member 10, that uses a switch 200 for automatically connecting/disconnecting the electrical connection between an electrical fixture and a power source which may be connected. FIG. 3 depicts the pole 300 in an illustrative operating position, while FIG. 4 depicts the pole 300 in an illustrative maintenance position. The switch 200 is fitted inside of the pole 300 adjacent the interconnecting means, and electrically connected between the power source (not shown) and the electrical fixture (not shown). An electrical cable 302 connects the power source to the switch 200, and an electrical cable 304 connects the switch 200 to the electrical fixture. The switch 200 may provide switching for one or more wires of the cables 302, 304 between the power source and the electrical fixture. For example, the switch 200 may only connect/disconnect the hot wire of the cables 302, 304, while the other wire or wires, for example neutral and/or ground, remain connected between the power source and the electrical fixture at all times. Alternatively, the switch 200 may switch all of the wires of the cables 302, 304.

The switch 200 is oriented within the pole such that the sensor 202 of the switch 200 is oriented so as to be able to measure movement of the pole, typically this means orienting the sensor 202 to be coplanar with the plane of movement of the pole. If multiple sensors 202 are incorporated into the switch 200, each sensor 202 may be aligned with a plane of movement of the pole. The switch 200 may be moulded into the cables 302, 304 with a length of cable coming in and out of the switch 200. The switch 200 may be situated inside the pole and hang just above the interconnecting means. The switch may be supported inside the pole by the electrical cable which may be secured inside the pole both by electrical connection and by an electrical tie wrap inside the pole. Even if the electrical cable supports fail the switch 200 may rest on the internal part of the interconnecting means.

As is apparent from FIGS. 3 and 4, when the pole 300 is in the illustrative operating position of FIG. 3, the switch 200 is oriented in a generally vertical position. The microcontroller 206 processes the sensor output signal 204 from the sensor 202, and determines that the switch 200, and so the pole 300, is generally vertical and so provides the appropriate microcontroller output signal 208 to the controllable switch 210 so as to connect the power between the power source and the electrical fixture. Similarly, when the pole 300 is in the illustrative maintenance position of FIG. 4, the microcontroller 206 processes the sensor output signal 204 from the sensor 202, and determines that the switch 200, and so the pole, is generally horizontal and so provides the appropriate microcontroller output signal 208 to the controllable switch 210 so as to connect the power between the power source and the electrical fixture.

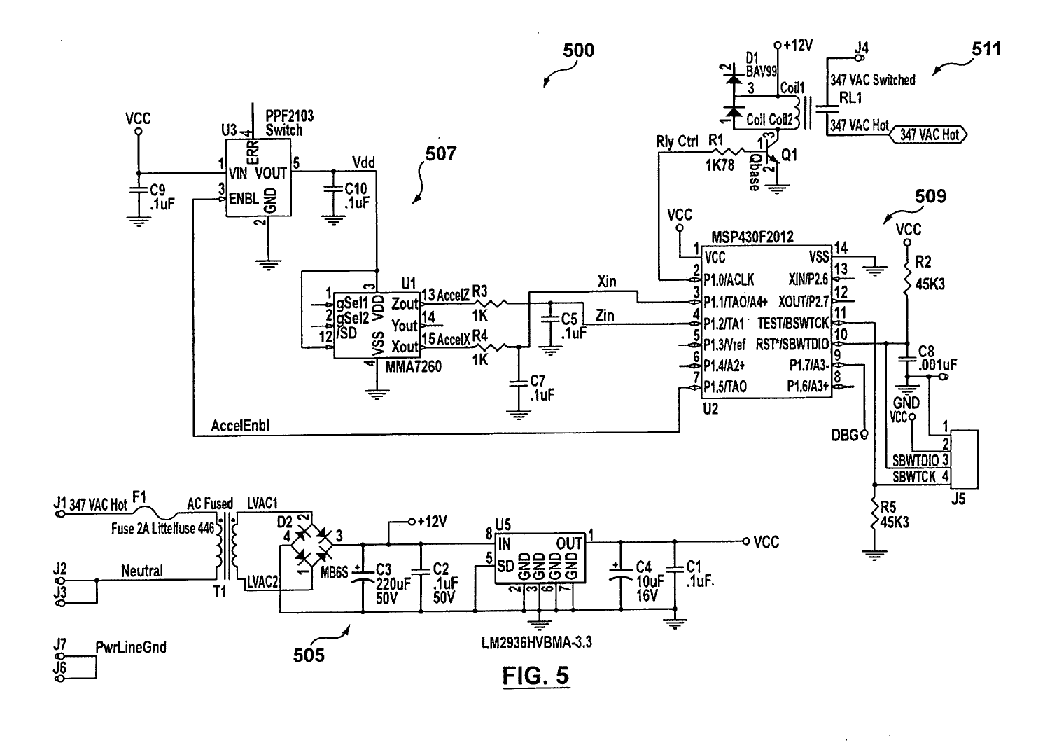

FIG. 5 depicts an electrical schematic of an illustrative switch 500. The switch 500 depicted in FIG. 5 provides automatic switching of a 347 VAC power line. The hot wire of the 347 VAC cable from the power source is connected to the switch 500 at J1. The neutral wire of the cable from the power source is connected to the switch 500 at J2, and the ground wire of the cable from the power source is connected to the switch 500 at J7. The switch 500 of FIG. 5 uses a single pole, single through relay RL1 that provides switching of the hot wire. The neutral wire of the cable connected to the electrical fixture is connected to the neutral wire of the cable connected to the power source at J3 of the switch 500, which is electrically connected to J2. Similarly, the ground wire of the cable connected to the electrical fixture is connected to the ground wire of the cable connected to the power source at J6 of the switch 500, which is electrically connected to J7. The hot wire of the cable connected to the electrical fixture is connected to the switch 500 at J4.

The switch 500 includes a transformer circuit 505 which provides the switch 500 with the required DC power from the AC power of the cable connected to the switch 500 at J1 and J2. The transformer circuit includes a 347V to 12V transformer T1, as well as a rectifier D2 for rectifying the AC power from the transformer T1 to DC power, and regulator U5 for providing regulated DC power. The unregulated DC power may be used by components of the switch 500 such as the coil of the relay RL1, while the regulated DC power may be used by other component of the switch 500 such as the sensor 507 and the microcontroller 509. If it is desirable to use a battery or other power source for operating the components of the switch 500, the transformer circuit, or parts of it, may be omitted.

The switch 500 includes a sensor circuit 507 which includes a load switch U3 which provides power to an accelerometer U1. The load switch U3 may be controlled by the microcontroller to selectively provide power to the accelerometer U1. The accelerometer U1 includes outputs for measuring the orientation of the accelerometer in 3 dimensions; however as shown in FIG. 5 only 2 of the sensor output signals (AccelZ and AccelX) are coupled to a microcontroller circuit 509.

The microcontroller circuit 509 includes a microcontroller U2 that processes the sensor output signals and provides a microcontroller output signal (RlyCtrl) to a controllable switch circuit 511. The controllable switch circuit 511 connects/disconnects the hot wire between the power source and the electrical fixture based on the microcontroller output signal. The microcontroller circuit 509 may also provide an output signal (AccelEnbl) to the sensor 507 which may control whether or not the load switch U3 provides power to the accelerometer U1.

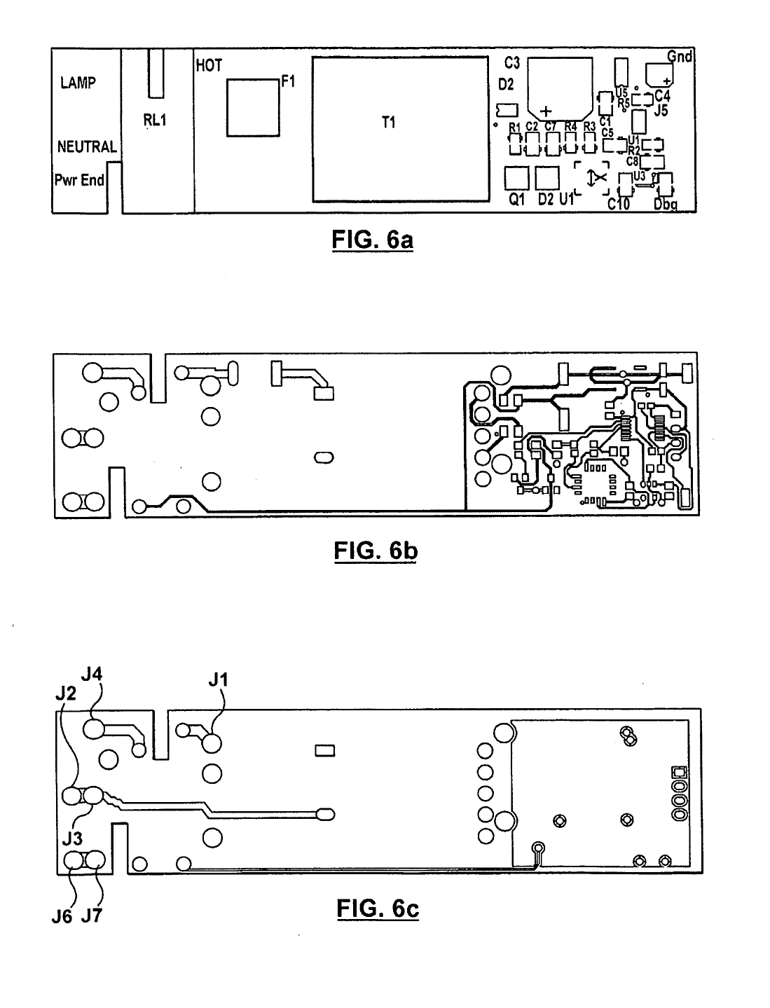

FIGS. 6a, 6b and 6c show an illustrative circuit board layout of the switch depicted in FIG. 5. FIG. 6a depicts the location of the individual components on a printed circuit board. FIG. 6b depicts the circuit traces on a top side of the printed circuit board, and FIG. 6b depicts the circuit traces on a bottom side of the printed circuit board. The connections, J1/J4, J2/J3, and J6/J7, for connecting the wires of the cables to the switch 500 are shown on FIG. 6c.

Table 1 describes the circuit components, and their values of the switch 500. The components and their values are for an illustrative switch 500 capable of switching 347 VAC. It is understood that the components, and their values, may be modified based on the requirements of a particular application.

TABLE 1
Table showing switch components and
their values

| Designator | Description | Value | Exemplary Mfg P/N |
|---|---|---|---|
| C8 | Capacitor | .001 uF | |
| C1, C2, C5, | Capacitor | .1 uF | |
| C7, C9, C10 | | | |
| C3 | Tantalum Capacitor | 220 uF | EEEFK1H221P |
| | | (50 V) | |
| C4 | Tantalum Capacitor | 10 uF | EEE-FK1C100R |
| | | (16 V) | |
| D1 | BAV99 Diode | | BAV99 |
| D2 | Diode Bridge | | MB6S |
| F1 | Fuse SMT | | 0446002.ZRP |
| DBG, GND | Test Connection | | 5015 |
| J5 | Header .1 R/A Gold 4 | | 68016-136HLF (break |
| | position | | apart) |
| Q1 | High Voltage NPN | | MMBT5551LT1 |
| | Transistor | | |
| R2, R5 | Resistor; SMT; 1% | 45K3 | |
| R1 | Resistor; SMT; 1% | 1K78 | |
| R3, R4 | Resistor; SMT; 1% | 1K | |
| U1 | Accelerometer 3-axis | | MMA6280 or MMA7260 |
| U2 | Microcontroller | | MSP430F2012IPW |
| U3 | Load Switch | | FPF2103 |
| U5 | LDO regulator | | LM2936HVBMA-3.3 |
| RL1 | Relay, SPST | | RTB34012F |
| T1 | 347 V:12 V | | Brownsberg VF12C |
| | transformer | | Rev1 |

The accelerometer U1 measures gravitational acceleration on two orthogonal axes perpendicular to the third axis. When the accelerometer U1 is in a perfectly vertical position, the output voltage on each of the two channels, Vx and Vz, is equal to some value V₀. When the accelerometer is tilted away from the vertical position, the output voltage on one or both of the channels Vx and Vz changes to a value either greater than or less than V₀. The difference between Vx and V₀ is proportional to the angle of tilt in the X axis as measured from vertical; similarly the difference between Vz and V₀ is proportional to the angle of tilt in the Z axis as measured from vertical.

The tilt signal Vx may be connected to an anti-alias filter comprised of R4 and C7, which provides part of the sensor output signal, then to an analog-to-digital converter that is an integral part of microcontroller U2. Similarly, the tilt signal Vz may be connected to an anti-alias filter comprised of R3 and C5, which provides part of the sensor output signal, then to the analog-to-digital converter of the microcontroller U2. As previously described, the switch 500 does not utilize the third output channel provided by the accelerometer U1, however one of ordinary skill in the art will recognize that the microcontroller could also process the accelerometer's output signal for the third axis, or alternatively could process only the accelerometer's output from a single axis.

The microcontroller U2 is configured to execute instructions stored in a memory of the microcontroller U2. The instructions when executed by the microcontroller, cause the sensor output signal, which may comprise tilt signals Vx and Vz, to be read from the analog-to-digital converter that is integrated with the microcontroller U2, and calculates the resultant tilt angle from the vertical, σ. If the tilt angle σ is greater than some designated setpoint, the microcontroller sets the microcontroller output signal, for example RlyCtrl=0V, to de-energize the relay RL1. This disconnects the power source from the electrical fixture. If the tilt angle σ is less than the setpoint, the microcontroller U2 sets the microcontroller output signal, for example RlyCtrl=10V, to energize the relay RL1, which connects the electrical fixture to the power source. Resistor R1 controls the current flow from the microcontroller U2 into the base of transistor Q1. Transistor Q1 amplifies the current to a magnitude sufficient to energize the coil of relay RL1. Diode D1 clamps the inductive current flowing in the coil of RL1 to prevent a voltage spike. If the coil of RL1 is energized, a normally-open contact on RL1 closes. This allows the flow of energy from the power source to the electrical fixture.

The instructions stored in memory that are executed by the microcontroller U2 may measure the tilt angle when power is first applied to the switch 500. This angle is designated as the zero angle. The zero angle is subtracted from the tilt angle, σ, when calculating the orientation of the switch 500. This allows the microcontroller to correct errors in the installation of the pole, where the pole is tilted from the vertical when it is in the operating position, or to correct errors in the installation of the switch 500 within the pole. This subtraction also allows the system to correct for deviations of the sensor output signal provided by the accelerometer U1 caused by changes in the ambient temperature. The accelerometer may provide different voltages at different temperatures for the same tilt angle. Temperature effects may be periodically calculated by the microcontroller U2, for example once per minute, and a compensating calculation is made to keep the error due to temperature within acceptable limits. The compensating calculation may modify the value of the zero angle to reflect a temperature corrected value.

The instructions executed by the microcontroller may provide additional processing of the sensor output signal. For example, the processing may provide the microcontroller U2 output signal to energize the relay RL1, and so connect the electrical fixture to the power source, only after the tilt angle σ has crossed the setpoint threshold for a given period of time, for example 10 seconds. This helps to ensure that possible movement caused by performing maintenance does not cause power to be connected to the electrical fixture while maintenance is being performed. Similarly a delay in providing the microcontroller output signal for de-energizing the relay RL1 may be used to prevent the switch from disconnecting power as a result of possible movement, for example due to wind or vibration. It is noted that it may be desirable to provide a shorter delay for disconnecting power to ensure that the power is disconnected from the electrical fixture by the time the pole is in the maintenance position. As such, the delay may be chosen to be less than the minimum time that is expected to be required to move the pole from an operating position to a maintenance position.

Component U3 is a solid state switch that allows the microcontroller U2 to turn the accelerometer U1 under control of the microcontroller. For correct cold temperature operation, the voltage to the accelerometer U1 may be required to rise to the correct operating value within a given time frame, for example 100 microseconds. If the accelerometer U1 is connected directly to the regulated DC power supplied by the transformer circuit 505, this rate of rise cannot be guaranteed. Using U3 to allow the microcontroller U2 to control the power to the accelerometer U1 allows this rise time specification to be met. Capacitor C9 filters the input voltage to U3, and capacitor C10 filters the input voltage to U1.

Transformer T1 converts the voltage of the lighting fixture, typically 347 VAC, to approximately 12 VAC for use by a control circuit of the transformer circuit 505. Fuse F1 stops the flow of current to the control circuit, of the transformer circuit 505, in the event of a short circuit. Diode bridge D2 converts the secondary voltage of T1 to a full wave rectified DC voltage. Capacitors C2 and C3 filter the rectified DC voltage. The filtered and rectified DC voltage may be used to energize the coil of relay RL1. Component U5 is a voltage regulator, which converts the rectified and filtered DC voltage to 3.3 VDC for use by the accelerometer U1, the microcontroller U2 and the load switch U3. Capacitors C4 and C1 filter the 3.3 VDC power supply. The instructions, as well as any data required by the microcontroller, for example the setpoint for the tilt angle, may loaded into the flash memory of the microcontroller U2 via connector J5. Resistors R2 and R5 and capacitor C8 condition the programming signals. This programming interface conforms to the Spy Bi-Wire system specified by Texas Instruments.

It will be appreciated that although a pole is referred to throughout the specification, any elongated member may be used for situating an electrical fixture. The present invention is not to be limited to only poles. Further, although the sections of the poles have been described as rotatable relative each other, it will be appreciated that the poles may pivot about the interconnecting means in a single plane and need not have full rotation about the interconnecting means, as described with reference to FIG. 1.

One or more currently illustrative embodiments have been described by way of example. It will be apparent to persons skilled in the art that a number of variations and modifications can be made without departing from the scope of the invention as defined in the claims.

In the drawings and specification, there have been disclosed typical embodiments on the invention and, although specific terms have been employed, they have been used in a generic and descriptive sense only and not for purposes of limitation, the scope of the invention being set forth in the following claims.

1. A switch for use in a pole for situating an electrical fixture remote from a base position, the pole moveable between an operating position and a maintenance position, the switch comprising:
a sensor for measuring an orientation of the switch;
a microcontroller for processing the orientation of the switch as measured by the sensor and providing a microcontroller output signal based on the processing of the orientation of the switch; and
a controllable switch for connecting and disconnecting the electrical fixture to and from a power source based on the microcontroller output signal.

2. The switch as claimed in claim 1, wherein the switch disconnects the electrical fixture from the power source when the switch is in an orientation corresponding to the maintenance position of the pole and connects the electrical fixture to the power source when the switch is in an orientation corresponding to the operating position of the pole.

3. The switch as claimed in claim 1, further comprising:
a transformer circuit for providing electrical power to the sensor, microcontroller and controllable switch from a power source.

4. The switch as claimed claim 1, wherein the sensor comprises a first accelerometer for measuring the orientation of the switch by measuring gravitational acceleration along a first axis and providing a sensor output signal to the microcontroller.

5. The switch as claimed in claim 4, wherein the sensor output signal is a voltage proportional to the gravitational acceleration measured by the first accelerometer.

6. The switch as claimed in claim 4, wherein the sensor further comprises one or more additional accelerometers for measuring gravitational acceleration along axes orthogonal to the first axis and wherein the sensor output signal to the microcontroller comprises voltage signals proportional to the gravitational acceleration measured by each of the one or more additional accelerometers.

7. The switch as claimed in claim 1, further comprising a switch operable by the microcontroller for selectively supplying power to the sensor.

8. The switch as claimed in claim 1, wherein the controllable switch is a relay controlled by the microcontroller output signal.

9. The switch as claimed in claim 3, wherein the transformer circuit comprises:
a transformer for transforming an alternating current (AC) input voltage to an AC output voltage;
a rectifier for rectifying the AC output voltage to a direct current (DC) voltage; and
a regulator for regulating the DC voltage to a microcontroller supply voltage.

10. The switch as claimed in claim 1, wherein the microcontroller comprises:
an analog to digital converter for converting analog voltage signals to digital signals;
a memory for storing instructions for processing the sensor output signal; and
a processor for executing the instructions stored in the memory.

11. The switch as claimed in claim 10, wherein the instructions for processing the sensor input comprise:
determining a zero angle based on the sensor output signal when power is applied to the microcontroller;
determining a position angle, σ, of the switch by determining a difference between an angle determined based on a current sensor output signal and the zero angle;
comparing the position angle, σ, to a setpoint to determine if the switch is in an orientation corresponding to the operating position of the pole or in an orientation corresponding to the maintenance position of the pole;
setting the microcontroller output signal to open the controllable switch and disconnect the electrical fixture from the power source when the switch is in the orientation corresponding to the maintenance position; and
setting the microcontroller output signal to close the controllable switch and connect the electrical fixture from the power source when the switch is the orientation corresponding to the operating position.

12. The switch as claimed in claim 11, wherein the instructions for processing the sensor input further comprise:
delaying setting the microcontroller output signal to close the controllable switch until the switch is in the operating position for a first predetermined amount of time.

13. The switch as claimed in claim 11, wherein the instructions for processing the sensor input further comprise:
delaying setting the microcontroller output signal to open the controllable switch until the switch is in the maintenance position for a second predetermined amount of time.

14. The switch as claimed in claim 13, wherein the first predetermined amount of time is larger than the second predetermined amount of time.

15. A moveable pole for locating an electrical fixture remote from a base position, the moveable pole comprising:
a pole moveable between an operating position and a maintenance position;
an electrical fixture mounted on the pole; and
a switch for automatically disconnecting power from the electrical fixture when the pole is in the maintenance position.

16. The moveable pole as claimed in claim 15, wherein the moveable pole moves between the operating position and a maintenance position about:
a hinge;
a pivot;
an angled axis; or
a flexible interconnecting means;
or a combination thereof.

17. The moveable pole as claimed in claim 15, wherein the moveable pole is for use in processing plants, refineries, construction sites or city street lighting.

18. An elongate member for locating an electrical fixture remote from a base position, the elongate member comprising:
an inner elongate portion, the inner elongate portion extending, in use, from the base position;
an outer elongate portion, the outer elongate portion being arranged to receive the electrical fixture;
an interconnecting means, the interconnecting means being arranged to connect the inner elongate portion to the outer elongate portion and to permit relative rotation of the inner and outer portions about an axis of rotation, the axis of rotation being disposed at an acute angle relative to a longitudinal axis of the inner elongate portion; and
a switch mechanically coupled to the outer elongate portion and electrically coupled to the electrical fixture and a cable for electrically coupling the switch to a power source.
